(19) United States
(12) Patent Application Publication
(10) Pub. No.: US 2003/0084326 A1
(43) Pub. Date: May 1, 2003

(54) Method, node and computer readable medium for identifying data in a network exploit

(76) Inventor: Richard Paul Tarquini, Apex, NC (US)

Correspondence Address: HEWLETT-PACKARD COMPANY, Intellectual Property Administration, P.O. Box 272400, Fort Collins, CO, 80527-2400, US

(21) Appl. No.: 10/002,697

(22) Filed: Oct. 31, 2001

(51) Int. Cl. G06F 11/30

(52) U.S. Cl. 713/200

(57) ABSTRACT

A method of identifying data comprised in a network exploit comprising receiving a packet by an intrusion prevention system maintained by a node of a network, the intrusion prevention system bound to a media access control driver and a protocol driver, invoking a signature analysis algorithm by the intrusion prevention system, and comparing the packet by the intrusion prevention system with a first rule set comprising a rule logically defining a packet signature is provided. A node of a network maintaining an instance of an intrusion prevention system, the node comprising a central processing unit, a memory module for storing data in machine-readable format for retrieval and execution by the central processing unit, and an operating system comprising a network stack comprising a protocol driver, a media access control driver and an instance of the intrusion prevention system bound to the protocol driver and the media access control driver, the intrusion prevention system comprising an associative process engine and an input/output control layer, the input/output control layer operable to receive a signature file generated from a network exploit rule comprising an operand, an operator and a mask, the input/output control layer operable to pass the signature file to the associative process engine, the associative process engine operable to analyze a data packet with the signature file and assign a logical value to the signature file dependent upon a result from the analysis is provided. A computer-readable medium having stored thereon a set of instructions to be executed, the set of instructions, when executed by a processor, cause the processor to perform a computer method of reading a data packet, selecting a set of a plurality of signature files from a plurality of sets of signature files, each respective signature file of the plurality of sets of signature files generated from a respective rule of at least one rule set comprised of a plurality of rules, and comparing the data packet with at least one signature file of the selected set is provided. is provided.

### CROSS-REFERENCE TO RELATED APPLICATIONS

This patent application is related to co-pending U.S. patent application, Ser. No. ______, entitled “METHOD AND COMPUTER READABLE MEDIUM FOR SUPPRESSING EXECUTION OF SIGNATURE FILE DIRECTIVES DURING A NETWORK EXPLOIT,” filed Oct. 31, 2001, co-assigned herewith; U.S. patent application, Ser. No. ______, entitled “SYSTEM AND METHOD OF DEFINING THE SECURITY CONDITION OF A COMPUTER SYSTEM,” filed Oct. 31, 2001, co-assigned herewith; U.S. patent application, Ser. No. ______, entitled “SYSTEM AND METHOD OF DEFINING THE SECURITY VULNERABILITIES OF A COMPUTER SYSTEM,” filed Oct. 31, 2001, co-assigned herewith; U.S. patent application, Ser. No. ______, entitled “SYSTEM AND METHOD OF DEFINING UNAUTHORIZED INTRUSIONS ON A COMPUTER SYSTEM,” filed Oct. 31, 2001, co-assigned herewith; U.S. patent application, Ser. No. ______, entitled “NETWORK INTRUSION DETECTION SYSTEM AND METHOD,” filed Oct. 31, 2001, co-assigned herewith; U.S. patent application, Ser. No. ______, entitled “NODE, METHOD AND COMPUTER READABLE MEDIUM FOR INSERTING AN INTRUSION PREVENTION SYSTEM INTO A NETWORK STACK,” filed Oct. 31, 2001, co-assigned herewith; U.S. patent application, Ser. No. ______, entitled “METHOD, COMPUTER-READABLE MEDIUM, AND NODE FOR DETECTING EXPLOITS BASED ON AN INBOUND SIGNATURE OF THE EXPLOIT AND AN OUTBOUND SIGNATURE IN RESPONSE THERETO,” filed Oct. 31, 2001, co-assigned herewith; U.S. patent application, Ser. No. ______, entitled “NETWORK, METHOD AND COMPUTER READABLE MEDIUM FOR DISTRIBUTED SECURITY UPDATES TO SELECT NODES ON A NETWORK,” filed Oct. 31, 2001, co-assigned herewith; U.S. patent application, Ser. No. ______, entitled “METHOD, COMPUTER READABLE MEDIUM, AND NODE FOR A THREE-LAYERED INTRUSION PREVENTION SYSTEM FOR DETECTING NETWORK EXPLOITS,” filed Oct. 31, 2001, co-assigned herewith; U.S. patent application, Ser. No. ______, entitled “SYSTEM AND METHOD OF AN OS-INTEGRATED INTRUSION DETECTION AND ANTI-VIRUS SYSTEM,” filed Oct. 31, 2001, co-assigned herewith; U.S. patent application, Ser. No. ______, entitled “NODE, METHOD AND COMPUTER READABLE MEDIUM FOR OPTIMIZING PERFORMANCE OF SIGNATURE RULE MATCHING IN A NETWORK,” filed Oct. 31, 2001, co-assigned herewith; U.S. patent application, Ser. No. ______, entitled “METHOD, NODE AND COMPUTER READABLE MEDIUM FOR PERFORMING MULTIPLE SIGNATURE MATCHING IN AN INTRUSION PREVENTION SYSTEM,” filed Oct. 31, 2001, co-assigned herewith; U.S. patent application, Ser. No. ______, entitled “USER INTERFACE FOR PRESENTING DATA FOR AN INTRUSION PROTECTION SYSTEM,” filed Oct. 31, 2001, co-assigned herewith; U.S. patent application, Ser. No. ______, entitled “NODE AND MOBILE DEVICE FOR A MOBILE TELECOMMUNICATIONS NETWORK PROVIDING INTRUSION DETECTION,” filed Oct. 31, 2001, co-assigned herewith; U.S. patent application, Ser. No. ______, entitled “METHOD AND COMPUTER-READABLE MEDIUM FOR INTEGRATING A DECODE ENGINE WITH AN INTRUSION DETECTION SYSTEM,” filed Oct. 31, 2001, co-assigned herewith; U.S. patent application, Ser. No. ______, entitled “SYSTEM AND METHOD OF GRAPHICALLY DISPLAYING DATA FOR AN INTRUSION PROTECTION SYSTEM,” filed Oct. 31, 2001, co-assigned herewith; and U.S. patent application, Ser. No. ______, entitled “SYSTEM AND METHOD OF GRAPHICALLY CORRELATING DATA FOR AN INTRUSION PROTECTION SYSTEM,” filed Oct. 31, 2001, co-assigned herewith.

### TECHNICAL FIELD OF THE INVENTION

This invention relates to network technologies, and more particularly, to a method, node and computer readable medium for identifying data in a network exploit.

### BACKGROUND OF THE INVENTION

Network-exploit attack tools, such as denial-of-service (DoS) attack utilities, are becoming increasing sophisticated and, due to evolving technologies, simple to execute. Relatively unsophisticated attackers can arrange, or be involved in, computer system compromises directed at one or more targeted facilities. A network system attack (also referred to herein as an intrusion) is an unauthorized or malicious use of a computer or computer network and may involve hundred or thousands of unprotected, or alternatively compromised, Internet nodes together in a coordinated attack on one or more selected targets.

Network attack tools based on the client/server model have become a preferred mechanism for executing network attacks on targeted networks or devices. High capacity machines in networks having deficient security are often desired by attackers to launch distributed attacks therefrom. University servers typically feature high connectivity and capacity but relatively mediocre security. Such networks also often have inexperienced or overworked network administrators making them even more vulnerable for involvement in network attacks.

Network-exploit attack tools, comprising hostile attack applications such as denial-of-service (DoS) utilities, responsible for transmitting data across a network medium will often have a distinctive “signature,” or recognizable pattern within the transmitted data. The signature may comprise a recognizable sequence of particular packets and/or recognizable data that is contained within one or more packets. Signature analysis is often performed by a network intrusion prevention system (IPS) and may be implemented as a pattern-matching algorithm and may comprise other signature recognition capabilities as well as higher-level application monitoring utilities. A simple signature analysis algorithm may search for a particular string that has been identified as associated with a hostile application. Once the string is identified within a network data stream, the one or more packets carrying the string may be identified as “hostile,” or exploitative, and the IPS may then perform any one or more of a number of actions, such as logging the identification of the frame, performing a countermeasure, or performing another data archiving or protection measure.

Intrusion prevention systems (IPS) encompass technology that attempts to identify exploits against a computer system or network of computer systems. Numerous types of IPSs exist and each are generally classified as either a network-based, host-based, or node-based IPS.

Network-based IPS appliances are typically dedicated systems placed at strategic places on a network to examine data packets to determine if they coincide with known attack signatures. To compare packets with known attack signatures, network-based IPS appliances utilize a mechanism referred to as passive protocol analysis to inconspicuously monitor, or “sniff,” all traffic on a network and to detect low-level events that may be discerned from raw network traffic. Network exploits may be detected by identifying patterns or other observable characteristics of network frames. Network-based IPS appliances examine the contents of data packets by parsing network frames and packets and analyzing individual packets based on the protocols used on the network. A network-based IPS appliance inconspicuously monitors network traffic inconspicuously, i.e., other network nodes may be, and often are, unaware of the presence of the network-based IPS appliance. Passive monitoring is normally performed by a network-based IPS appliance by implementation of a “promiscuous mode” access of a network interface device. A network interface device operating in promiscuous mode copies packets directly from the network media, such as a coaxial cable, 100baseT or other transmission medium, regardless of the destination node to which the packet is addressed. Accordingly, there is no simple method for transmitting data across the network transmission medium without the network-based IPS appliance examining it and thus the network-based IPS appliance may capture and analyze all network traffic to which it is exposed. Upon identification of a suspicious packet, i.e., a packet that has attributes corresponding to a known attack signature monitored for occurrence by the network-based IPS appliance, an alert may be generated thereby and transmitted to a management module of the IPS so that a networking expert may implement security measures. Network-based IPS appliances have the additional advantage of operating in real-time and thus can detect an attack as it is occurring. Moreover, a network-based IPS appliance is ideal for implementation of a state-based IPS security measure that requires accumulation and storage of identified suspicious packets of attacks that may not be identified “atomically,” that is by a single network packet. For example, transmission control protocol (TCP) synchronization (SYN) flood attacks are not identifiable by a single TCP SYN packet but rather are generally identified by accumulating a count of TCP SYN packets that exceed a predefined threshold over a defined period of time. A network-based IPS appliance is therefore an ideal platform for implementing state-based signature detection because the network-based IPS appliance may collect all such TCP SYN packets that pass over the local network media and thus may properly archive and analyze the frequency of such events.

However, network-based IPS appliances may often generate a large number of “false positives,” i.e., incorrect diagnoses of an attack. False positive diagnoses by network-based IPS appliances result, in part, due to errors generated during passive analysis of all the network traffic captured by the IPS that may be encrypted and formatted in any number of network supported protocols. Content scanning by a network-based IPS is not possible on an encrypted link although signature analysis based on protocol headers may be performed regardless of whether the link is encrypted or not. Additionally, network-based IPS appliances are often ineffective in high speed networks. As high speed networks become more commonplace, software-based network-based IPS appliances that attempt to sniff all packets on a link will become less reliable. Most critically, network-based IPS appliances can not prevent attacks unless integrated with, and operated in conjunction with, a firewall protection system.

Host-based IPSs detect intrusions by monitoring application layer data. Host-based IPSs employ intelligent agents to continuously review computer audit logs for suspicious activity and compare each change in the logs to a library of attack signatures or user profiles. Host-based IPSs may also poll key system files and executable files for unexpected changes. Host-based IPSs are referred to as such because the IPS utilities reside on the system to which they are assigned to protect. Host-based IPSs typically employ application-level monitoring techniques that examine application logs maintained by various applications. For example, a host-based IPS may monitor a database engine that logs failed access attempts and/or modifications to system configurations. Alerts may be provided to a management node upon identification of events read from the database log that have been identified as suspicious. Host-based IPSs, in general, generate very few false-positives. However, host-based IPS such as log-watchers are generally limited to identifying intrusions that have already taken place and are also limited to events occurring on the single host. Because log-watchers rely on monitoring of application logs, any damage resulting from the logged attack will generally have taken place by the time the attack has been identified by the IPS. Some host-based IPSs may perform intrusion-preventative functions such as ‘hooking’ or ‘intercepting’ operating system application programming interfaces to facilitate execution of preventative operations by an IPS based on application layer activity that appears to be intrusion-related. Because an intrusion detected in this manner has already bypassed any lower level IPS, a host-based IPS represents a last layer of defense against network exploits. However, host-based IPSs are of little use for detecting low-level network events such as protocol events.

Node-based IPSs apply the intrusion detection and/or prevention technology on the system being protected. An example of node-based IPS technologies is inline intrusion detection. A node-based IPS may be implemented at each node of the network that is desired to be protected. Inline IPSs comprise intrusion detection technologies embedded in the protocol stack of the protected network node. Because the inline IPS is embedded within the protocol stack, both inbound and outbound data will pass through, and be subject to monitoring by, the inline IPS. An inline IPS overcomes many of the inherent weaknesses of network-based solutions. As mentioned hereinabove, network-based solutions are generally ineffective when monitoring high-speed networks due to the fact that network-based solutions attempt to monitor all network traffic on a given link. Inline intrusion prevention systems, however, only monitor traffic directed to the node on which the inline IPS is installed. Thus, attack packets can not physically bypass an inline IPS on a targeted machine because the packet must pass through the protocol stack of the targeted device. Any bypassing of an inline IPS by an attack packet must be done entirely by ‘logically’ bypassing the IPS, i.e., an attack packet that evades an inline IPS must do so in a manner that causes the inline IPS to fail to identify, or improperly identify, the attack packet. Additionally, inline IPSs provide the hosting node with low-level monitoring and detection capabilities similar to that of a network IPS and may provide protocol analysis and signature matching or other low-level monitoring or filtering of host traffic. The most significant advantage offered by inline IPS technologies is that attacks are detected as they occur. Whereas host-based IPSs determine attacks by monitoring system logs, inline intrusion detection involves monitoring network traffic and isolating those packets that are determined to be part of an attack against the hosting server and thus enabling the inline IPS to actually prevent the attack from succeeding. When a packet is determine to be part of an attack, the inline IPS layer may discard the packet thus preventing the packet from reaching the upper layer of the protocol stack where damage may be caused by the attack packet—an effect that essentially creates a local firewall for the server hosting the inline IPS and protecting it from threats coming either from an external network, such as the Internet, or from within the network. Furthermore, the inline IPS layer may be embedded within the protocol stack at a layer where packets have been unencrypted so that the inline IPS is effective operating on a network with encrypted links. Additionally, inline IPSs can monitor outgoing traffic because both inbound and outbound traffic respectively destined to and originating from a server hosting the inline IPS must pass through the protocol stack.

Although the advantages of inline IPS technologies are numerous, there are drawbacks to implementing such a system. Inline intrusion detection is generally processor intensive and may adversely effect the node's performance hosting the detection utility. Additionally, inline IPSs may generate numerous false positive attack diagnoses. Furthermore, inline IPSs cannot detect systematic probing of a network, such as performed by reconnaissance attack utilities, because only traffic at the local server hosting the inline IPS is monitored thereby.

Each of network-based, host-based and inline-based IPS technologies have respective advantages as described above. Ideally, an intrusion prevention system will incorporate all of the aforementioned intrusion detection strategies. Additionally, an IPS may comprise one or more event generation mechanisms that report identifiable events to one or more management facilities. An event may comprise an identifiable series of system or network conditions or it may comprise a single identified condition. An IPS may also comprise an analysis mechanism or module and may analyze events generated by the one or more event generation mechanisms. A storage module may be comprised within an IPS for storing data associated with intrusion-related events. A countermeasure mechanism may also be comprised within the IPS for executing an action intended to thwart, or negate, a detected exploit.

Prior art intrusion prevention systems do not provide system administrators with a dynamic regular expression engine for detecting and preventing network exploits in real time. Typical expression engines for IPSs allow an administrator to define a filter that captures network data but typically do not prevent the exploit from reaching the target node. Other prior art IPSs utilize text-based signature descriptions for defining signature expressions that may be scanned in an offline mode.

### SUMMARY OF THE INVENTION

In accordance with an embodiment of the present invention, a method of identifying data comprised in a network exploit comprising receiving a packet by an intrusion prevention system maintained by a node of a network, the intrusion prevention system bound to a media access control driver and a protocol driver, invoking a signature analysis algorithm by the intrusion prevention system, and comparing the packet by the intrusion prevention system with a first rule set comprising a rule logically defining a packet signature is provided.

In accordance with another embodiment of the present invention, a node of a network maintaining an instance of an intrusion prevention system, the node comprising a central processing unit, a memory module for storing data in machine-readable format for retrieval and execution by the central processing unit, and an operating system comprising a network stack comprising a protocol driver, a media access control driver and an instance of the intrusion prevention system bound to the protocol driver and the media access control driver, the intrusion prevention system comprising an associative process engine and an input/output control layer, the input/output control layer operable to receive a signature file generated from a network exploit rule comprising an operand, an operator and a mask, the input/output control layer operable to pass the signature file to the associative process engine, the associative process engine operable to analyze a data packet with the signature file and assign a logical value to the signature file dependent upon a result from the analysis is provided.

In accordance with another embodiment of the present invention, a computer-readable medium having stored thereon a set of instructions to be executed, the set of instructions, when executed by a processor, cause the processor to perform a computer method of reading a data packet, selecting a set of a plurality of signature files from a plurality of sets of signature files, each respective signature file of the plurality of sets of signature files generated from a respective rule of at least one rule set comprised of a plurality of rules, and comparing the data packet with at least one signature file of the selected set is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates an exemplary arrangement for executing a computer system compromise as is known in the art;

FIG. 2 illustrates a comprehensive intrusion prevention system employing network-based and hybrid host-based and node based intrusion detection technologies according to an embodiment of the invention;

FIG. 3 is an exemplary network protocol stack according to the prior art;

FIG. 4 illustrates a network node that may run an instance of an intrusion protection system application according to an embodiment of the present invention;

FIG. 5 illustrates an exemplary network node that may operate as a management node within a network protected by the intrusion protection system according to an embodiment of the present invention;

FIG. 6 is a simplified schematic of an inline intrusion prevention system of an intrusion prevention application implemented as an intermediate driver of a network stack according to an embodiment of the invention;

FIG. 7 represent an exemplary protocol-parametric association of rules according to an embodiment of the invention;

FIG. 8 illustrates a table that maintains a parametric association of rules in a hierarchical manner managed with a node having an instance of an intermediate driver within a protocol stack according to an embodiment of the invention; and

FIG. 9 is a flowchart illustrating an exemplary processing routine of a common rule set and protocol specific rule sets according to an embodiment of the invention.

### DETAILED DESCRIPTION OF THE DRAWINGS

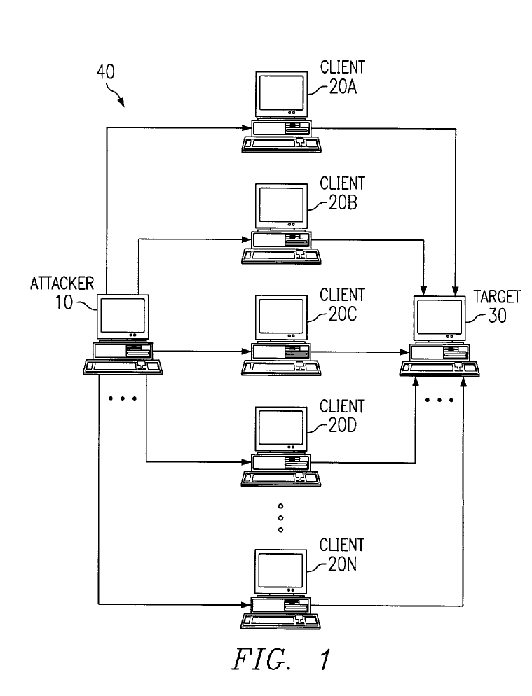

The preferred embodiment of the present invention and its advantages are best understood by referring to FIGS. 1 through 9 of the drawings, like numerals being used for like and corresponding parts of the various drawings.

In FIG. 1, there is illustrated an exemplary arrangement for executing a computer system compromise—the illustrated example showing a simplified distributed intrusion network 40 arrangement typical of distributed system attacks directed at a target machine 30. An attack machine 10 may direct execution of a distributed attack by any number of attack agents 20A-20N by one of numerous techniques such as remote control by IRC “robot” applications. Attack agents 20A-20N, also referred to as “zombies” and “attack agents,” are generally computers that are available for public use or that have been compromised such that a distributed attack may be launched upon command of an attack machine 10. Numerous types of distributed attacks may be launched against a target machine 30. The target machine 30 may suffer extensive damage from simultaneous attack by attack agents 20A-20N and the attack agents 20A-20N may be damaged from the client attack application as well. A distributed intrusion network may comprise an additional layer of machines involved in an attack intermediate the attack machine 10 and attack agents 20A-20N. These intermediate machines are commonly referred to as “handlers” and each handler may control one or more attack agents 20A-20N. The arrangement shown for executing a computer system compromise is illustrative only and may compromise numerous arrangements that are as simple as a single attack machine 10 attacking a target machine 30 by, for example, sending malicious probe packets or other data intended to compromise target machine 30. Target machine may be, and often is, connected to a larger network and access thereto by attack machine 10 may cause damage to a large collection of computer systems commonly located within the network.

In FIG. 2, there is illustrated a comprehensive intrusion prevention system employing network-based and hybrid host-based/node-based intrusion detection technologies according to an embodiment of the invention. One or more networks 100 may interface with the Internet 50 via a router 45 or other device. In the illustrative example, two Ethernet networks 55 and 56 are comprised in network 100. Ethernet network 55 comprises a web-content server 270A and a file transport protocol-content server 270B. Ethernet network 56 comprises a domain name server 270C, a mail server 270D, a database sever 270E and a file server 270F. A firewall/proxy router 60 disposed intermediate Ethernets 55 and 56 provides security and address resolution to the various systems of network 56. A network-based IPS appliance 80 and 81 is respectively implemented on both sides of firewall/proxy router 60 to facilitate monitoring of attempted attacks against one or more elements of Ethernets 55 and 56 and to facilitate recording successful attacks that successfully penetrate firewall/proxy router 60. Network-based IPS appliances 80 and 81 may respectively comprise (or alternatively be connected to) a database 80A and 81A of known attack signatures, or rules, against which network frames captured thereby may be compared. Alternatively, a single database (not shown) may be centrally located within network 100 and may be accessed by network-based IPS appliances 80 and 81. Accordingly, network-based IPS appliance 80 may monitor all packets inbound from Internet 50 to network 100 arriving at Ethernet network 55. Similarly, a network-based IPS appliance 81 may monitor and compare all packets passed by firewall/proxy router 60 for delivery to Ethernet network 56. An IPS management node 85 may also be part of network 100 to facilitate configuration and management of the IPS components in network 100.

In view of the above-noted deficiencies of network-based intrusion prevention systems, a hybrid host-based and node-based intrusion prevention system is preferably implemented within each of the various nodes, such as servers 270A-270N (also referred to herein as “nodes”), of Ethernet networks 55 and 56 in the secured network 100. Management node 85 may receive alerts from respective nodes within network 100 upon detection of an intrusion event by any one of the network-based IPS appliances 80 and 81 as well as any of the nodes of network 100 having a hybrid agent-based and node-based IPS implemented thereon. Additionally, each node 270A-270F may respectively employ a local file system for archiving intrusion-related events, generating intrusion-related reports, and storing signature files against which local network frames and/or packets are examined.

Preferably, network-based IPS appliances 80 and 81 are dedicated entities for monitoring network traffic on associated Ethernets 55 and 56 of network 100. To facilitate intrusion detection in high speed networks, network-based IPS appliances 80 and 81 preferably comprise a large capture RAM for capturing packets as they arrive on respective Ethernet networks 55 and 56. Additionally, it is preferable that network-based IPS appliances 80 and 81 respectively comprise hardware-based filters for filtering network traffic, although IPS filtering by network-based IPS appliances 80 and 81 may be implemented in software. Moreover, network-based IPS appliances 80 and 81 may be configured, for example by demand of IPS management node 85, to monitor one or more specific devices rather than all devices on a common network. For example, network-based IPS appliance 80 may be directed to monitor only network data traffic addressed to web server 270A.

Hybrid host-based/node-based intrusion prevention system technologies may be implemented on all nodes 270A-270N on Ethernet networks 55 and 56 that may be targeted by a network attack. In general, each node is comprised of a reprogrammable computer having a central processing unit (CPU), a memory module operable to store machine-readable code that is retrievable and executable by the CPU, and may further comprise various peripheral devices, such as a display monitor, a keyboard, a mouse or another device, connected thereto. A storage media, such as a magnetic disc, an optical disc or another component operable to store data, may be connected to memory module and accessible thereby and may provide one or more databases for archiving local intrusion events and intrusion event reports. An operating system may be loaded into memory module, for example upon bootup of the respective node, and comprises an instance of a protocol stack as well as various low-level software modules required for tasks such as interfacing to peripheral hardware, scheduling of tasks, allocation of storage as well as other system tasks. Each node protected by the hybrid host-based and node-based IPS of the present invention accordingly has an IPS software application maintained within the node, such as in a magnetic hard disc, that is retrievable by the operating system and executable by the central processing unit. Additionally, each node executing an instance of the IPS application has a local database from which signature descriptions of documented attacks may be fetched from storage and compared with a packet or frame of data to detect a correspondence therebetween. Detection of a correspondence between a packet or frame at an IDS server may result in execution of any one or more of various security procedures.

The IPS described with reference to FIG. 2 may be implemented on any number of platforms. Each hybrid host-based/node-based instance of the IPS application described herein is preferably implemented on a network node, such as web server 270A operated under control of an operating system, such as Windows NT 4.0 that is stored in a main memory and running on a central processing unit, and attempts to detect attacks targeted at the hosting node. The particular network 100 illustrated in FIG. 2 is exemplary only and may comprise any number of network servers. Corporate, and other large scale, networks may typically comprise numerous individual systems providing similar services. For example, a corporate network may comprise hundreds of individual web servers, mail servers, FTP servers and other systems providing common data services.

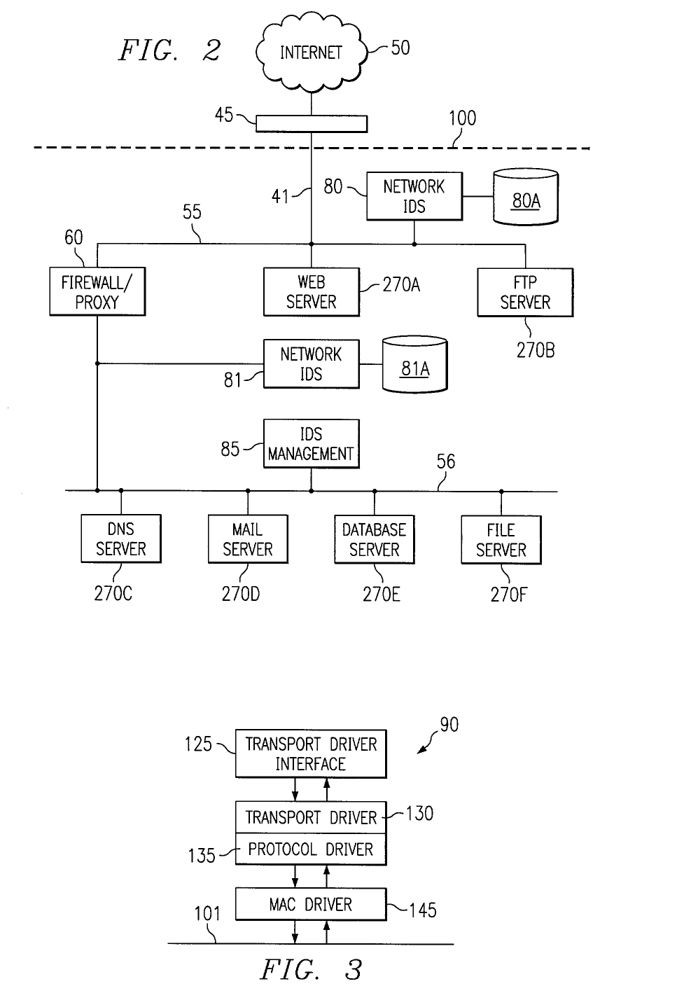

Each operating system of a node incorporating an instance of an IPS application additionally comprises a network protocol stack 90, as illustrated in FIG. 3, that defines the entry point for frames received by a targeted node from the network, e.g. the Internet or Intranet. Network stack 90 as illustrated is representative of the well-known WindowsNT (TM) system network protocol stack and is so chosen to facilitate discussion and understanding of the invention. However, it should be understood that the invention is not limited to a specific implementation of the illustrated network stack 90 but, rather, stack 90 is described to facilitate understanding of the invention. Network stack 90 comprises a transport driver interface (TDI) 125, a transport driver 130, a protocol driver 135 and a media access control (MAC) driver 145 that interfaces with the physical media 101. Transport driver interface 125 functions to interface the transport driver 130 with higher-level file system drivers. Accordingly, TDI 125 enables operating system drivers, such as network redirectors, to activate a session, or bind, with the appropriate protocol driver 135. Accordingly, a redirector can access the appropriate protocol, for example UDP, TCP, NetBEUI or other network or transport layer protocol, thereby making the redirector protocol-independent. The protocol driver 135 creates data packets that are sent from the computer hosting the network protocol stack 90 to another computer or device on the network or another network via the physical media 101. Typical protocols supported by an NT network protocol stack comprise NetBEUI, TCP/IP, NWLink, Data Link Control (DLC) and AppleTalk although other transport and/or network protocols may be comprised. MAC driver 145, for example an Ethernet driver, a token ring driver or other networking driver, provides appropriate formatting and interfacing with the physical media 101 such as a coaxial cable or another transmission medium.

The capabilities of the host-based IPS comprise application monitoring of: file system events; registry access; successful security events; failed security events and suspicious process monitoring. Network access applications, such as Microsoft IIS and SQL Server, may also have processes related thereto monitored.

Intrusions may be prevented on a particular IPS host by implementation of inline, node-based monitoring technologies. The inline-IPS is preferably comprised as part of a hybrid host-based/node-based IPS although it may be implemented independently of any host-based IPS system. The inline-IPS will analyze packets received at the hosting node and perform signature analysis thereof against a database of known signatures by network layer filtering.

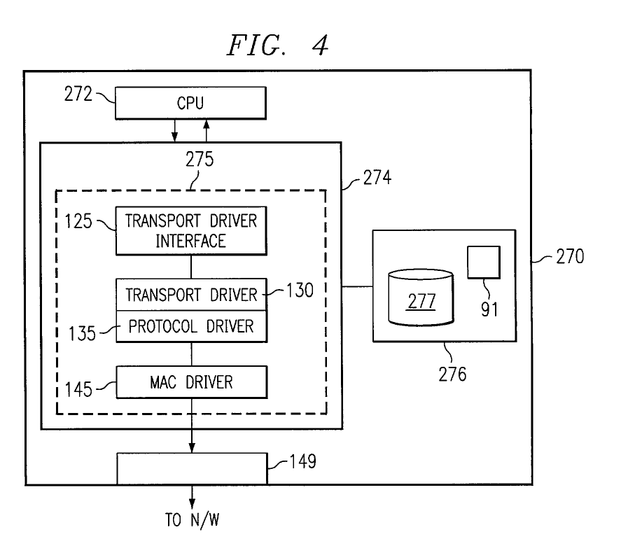

In FIG. 4, there is illustrated a network node 270 that may run an instance of an IPS application 91 and thus operate as an IPS server. IPS application 91 may be implemented as a three-layered IPS, as described in co-pending application entitled “Method, Computer Readable Medium, and Node for a Three-Layered Intrusion Prevention System for Detecting Network Exploits” and filed concurrently herewith, and may comprise a server application and/or a client application. Network node 270, in general, comprises a central processing unit (CPU) 272 and a memory module 274 operable to store machine-readable code that is retrievable and executable by CPU 272 via a bus (not shown). A storage media 276, such as a magnetic disc, an optical disc or another component operable to store data, may be connected to memory module 274 and accessible thereby by the bus as well. An operating system 275 may be loaded into memory module 274, for example upon bootup of node 270, and comprises an instance of protocol stack 90 and may have an intrusion prevention system application 91 loaded from storage media 276. One or more network exploit rules may be compiled into a machine-readable signature(s) and stored within a database 277 that is loadable into memory module 274 and may be retrieved by IPS application 91 for facilitating analysis of network frames and/or packets according to an embodiment of the present invention.

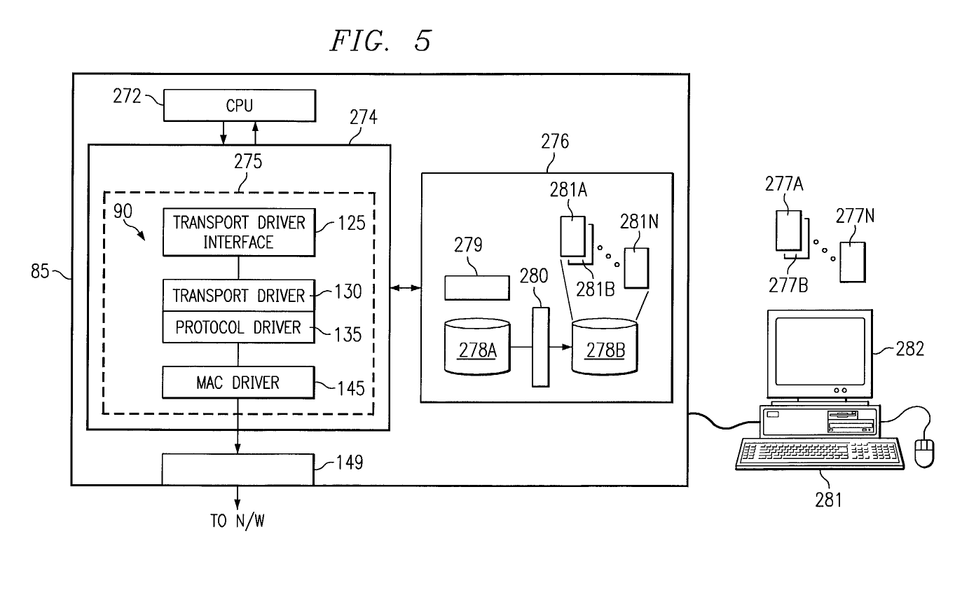

In FIG. 5, there is illustrated an exemplary network node that may operate as a management node 85 of the IPS of a network 100. Management node 85, in general, comprises a CPU 272 and a memory module 274 operable to store machine-readable code that is retrievable and executable by CPU 272 via a bus (not shown). A storage media 276, such as a magnetic disc, an optical disc or another component operable to store data, may be connected to memory module 274 and accessible thereby by the bus as well. An operating system 275 may be loaded into memory module 274, for example upon bootup of node 85, and comprises an instance of protocol stack 90. Operating system 275 is operable to fetch an IPS management application 279 from storage media 276 and load management application 279 into memory module 274 where it may be executed by CPU 272. Node 85 preferably has an input device 281, such as a keyboard, and an output device 282, such as a monitor, connected thereto.

An operator of management node 85 may input one or more text-files 277A-277N via input device 281. Each text-file 277A-277N may define a network-based exploit and comprise a logical description of an attack signature as well as IPS directives to execute upon an IPS evaluation of an intrusion-related event associated with the described attack signature. Each text file 277A-277N may be stored in a database 278A on storage media 276 and compiled by a compiler 280 into a respective machine-readable signature file 281A-281N that is stored in a database 278B. Each of the machine-readable signature files 281A-281N comprises binary logic representative of the attack signature as described in the respectively associated text-file 277A-277N. An operator of management node 85 may periodically direct management node 85, through interaction with a client application of IPS application 279 via input device 281, to transmit one or more machine-readable signature files (also generally referred to herein as “signature files”) stored in database 278B to a node, or a plurality of nodes, in network 100. Alternatively, signature files 281A-281N may be stored on a computer-readable medium, such as a compact disk, magnetic floppy disk or another portable storage device, and installed on node 270 of network 100. Application 279 is preferably operable to transmit all such signature-files 281A-281N, or one or more subsets thereof, to a node, or a plurality of nodes, in network 100. Preferably, IPS application 279 provides a graphical user interface on output device 282 for facilitating input of commands thereto by an operator of node 85.

Preferably, an inline intrusion prevention system of IPS application 91 of the present invention is implemented as an intermediate driver 147 of network stack 90A, as illustrated in FIG. 6, and bound to MAC driver 145 and protocol driver 135 and comprises an input/output control layer 147A, an intrusion event manager 147B, an associative process engine 147C and an input subnet filter 147D. Preferably, intermediate driver 147 (also referred to as network filter service provider) is developed according to Network Device Interface Specifications (NDIS) thus facilitating usage of multiple protocols on a common network hardware component such as a network interface card (NIC) 149. Intermediate driver 147 may advantageously remove frames from the network stream in both the inbound and outbound directions due to installation thereof in the network layer of network stack 90A.

Network exploit signatures are preferably defined in text files 277A-277N using an expression syntax, converted to machine-readable signature files 281A-281N and sent to network node 270 where associative process engine 147C may receive one or more signature files 281A-281N by way of input/output control layer 147A of intermediate driver 147. Network exploits may be defined at a central location, an exemplary technique described in co-pending application entitled “Network, Method and Software Application for Distributing Security Updates to Select Nodes on a Network” and filed concurrently herewith, and distributed throughout network 100 having a plurality of nodes each respectively comprising an instance of intermediate driver 147.

An expression form defining text-based exploit signatures according to the present invention may be described by equation 1:

resultₓ=(Operandₓ Operatorₓ Maskₓ) eq. 1

where:

Operand—network frame data

Operator—bitwise operation

Mask—operator mask.

Applications, comprising hostile attack applications such as DoS utilities, responsible for transmitting data across a network medium will often have a distinctive “signature,” or recognizable pattern within the transmitted data. The signature may comprise a recognizable sequence of particular packets and/or recognizable data that is contained within one or more frames. Signature analysis may be performed by IPS application 91 that has signature recognition capabilities such as a pattern-matching algorithm implemented by associative process engine 147C and may comprise other signature recognition capabilities. Once one or more signature files of database 277 are found to have a correspondence with a network data stream, frame, or packet, IPS application 91 may then perform any one or more of a number of actions, such as logging the signature identification, dropping the identified hostile packet/s, performing a countermeasure, executing a data archiving procedure, or performing another protection measure.

In the present invention, a signature of a network is defined by one or more expressions of the form described in equation 1. Each expression has a result or logical value component. The logical value of the one or more expressions defines a rule for detecting the associated network exploit. Accordingly, a rule to detect and/or prevent an exploit having a given signature takes the form of equation 2:

result=((resultₙˆ ₙ₋₁ resultₙ₋₁)ˆ ₙ₋₂ . . . ˆ ₀ result₀), eq. 2

where: ˆ is a (non-bitwise) logical operator, such as a logical AND, OR, XOR, or other Boolean function.

For example, a signature to detect an unassigned IP protocol payload exploit may identify such an IP packet by recognizing the protocol field of the IP header as having a value greater than 100 or any one of protocol field values in the range of 54 to 61 and, accordingly, a signature syntax would take the form:

If (IP[9:1]>100) OR (IP[9:1]>54 AND IP[9:1]<61).

The signature may be parsed into the following expressions:

Result Expression₀=IP[9:1]<61

Result Expression₁=IP[9:1]>54

Result Expression₂=IP[9:1]>100

where:

| | | |
|---|---|---|
| Operand₀ = ip[9:1] | Operator₀ = LessThan | Mask₀ = 61 |
| Operand₁ = ip[9:1] | Operator₁ = GreaterThan | Mask₁ = 54 |
| Operand₂ = ip[9:1] | Operator₂ = GreaterThan | Mask₂ = 100 |
| LogicalOperation₁ = OR | LogicalOperation₀ = AND | — |

A text file 277A comprising a composite rule, as defined by equation 3, may then be converted into machine-readable code by compiler 278A and stored in database 277 and/or 278B.

Composite Rule: result=(((Operand₀ Operator₀ Mask₀)LogicalOperation₀ (Operand₁ Operator₁Mask₁))LogicalOperation₁(Operand₂Operator₂Mask₂)) eq. 3

Machine-readable code in the form of a signature file 281A-281N generated from compilation of the composite rule may be distributed from management node 85 to one or more IPS servers of network 100 where it may be passed to associative process engine 147C where a pattern matching algorithm is employed to compare the machine-readable code signature file with network frames or packets. A plurality of machine-readable signature files resulting from compilation of composite rules may be combined into a rule set and fed into intermediate driver 147 for filtering of network frames thereby and described more fully hereinbelow.

Associative process engine 147C reduces the impact of inherent latency associated with processing of network frames received by intermediate driver 147 by utilizing parametric information to search a rule set of one or more machine-readable signatures. Parametric information allows associative process engine 147C to avoid analyzing the received frame against signatures that are parametrically unrelated to the received frame. For example, signatures may be parametrically classified according to the particular protocol from which the signatures were defined in the associated text file 277A. For example, a signature defined from an exploit that utilizes a transport control protocol exploit mechanism need not be used for analysis of a received user datagram protocol (UDP) frame. Other parametric classifications that may be used, in addition to the protocol parameter, to reduce the amount of analysis by intermediate driver 147 comprise a parameter specifying the size of operands in bytes, a protocol offset parameter, a transport layer protocol parameter, or another parametric classification.

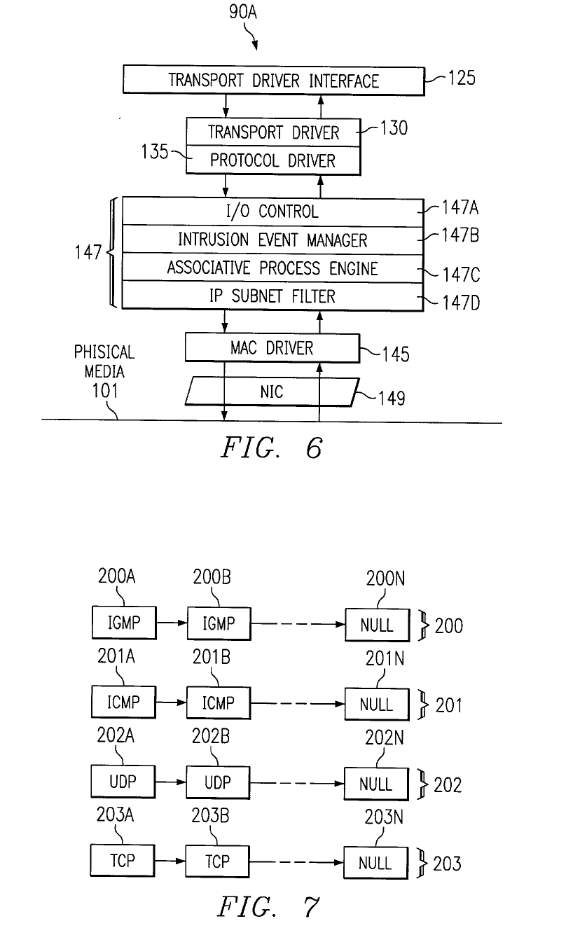

An exemplary protocol-parametric association of rules is represented in FIG. 7 according to an embodiment of the invention. One or more rule sets 200-203 each comprise at least one respective rule 200A-200N, 201A-201N, 202A-202N and 203A-203N. Each rule 200A-200N, 201A-201N, 202A-202N and 203A-203 preferably complies with the above-described composite rule format. Each rule set 200-203 may be terminated with a respective null rule, or null operator, 200N-203N. As a packet or frame is received by a node executing intermediate driver 147, the packet protocol is determined and a corresponding rule set 200-203 is then analyzed for a match between a defined rule and the packet 200A-200N signature. A protocol-specific rule set 203 may comprise a plurality of rules 203A-203B defining exploit signatures specific to packets formatted according to the TCP protocol. For example, rule set 203 may comprise rule 203A that defines the signature of a TCP network exploit commonly known as WinNuke. WinNuke is a well-documented TCP denial-of-service exploit in which a hostile sender specifies “out-of-band” data by setting the urgent (URG) bit flag in the TCP header. An URG pointer is then used by the receiver of the TCP packet to determine where in the segment the urgent data ends. Windows(TM)-based machines are unable to handle the out-of-band data and typically crash in response to reception of the data. Another rule 203B may define the exploit signature of the TCP trojan program known as NetBus (described in the appendix included hereinbelow). Thus, avoidance of comparing a received TCP packet with protocol specific rules 200-202 defining exploit signatures with which a match can not possibly be made is provided.

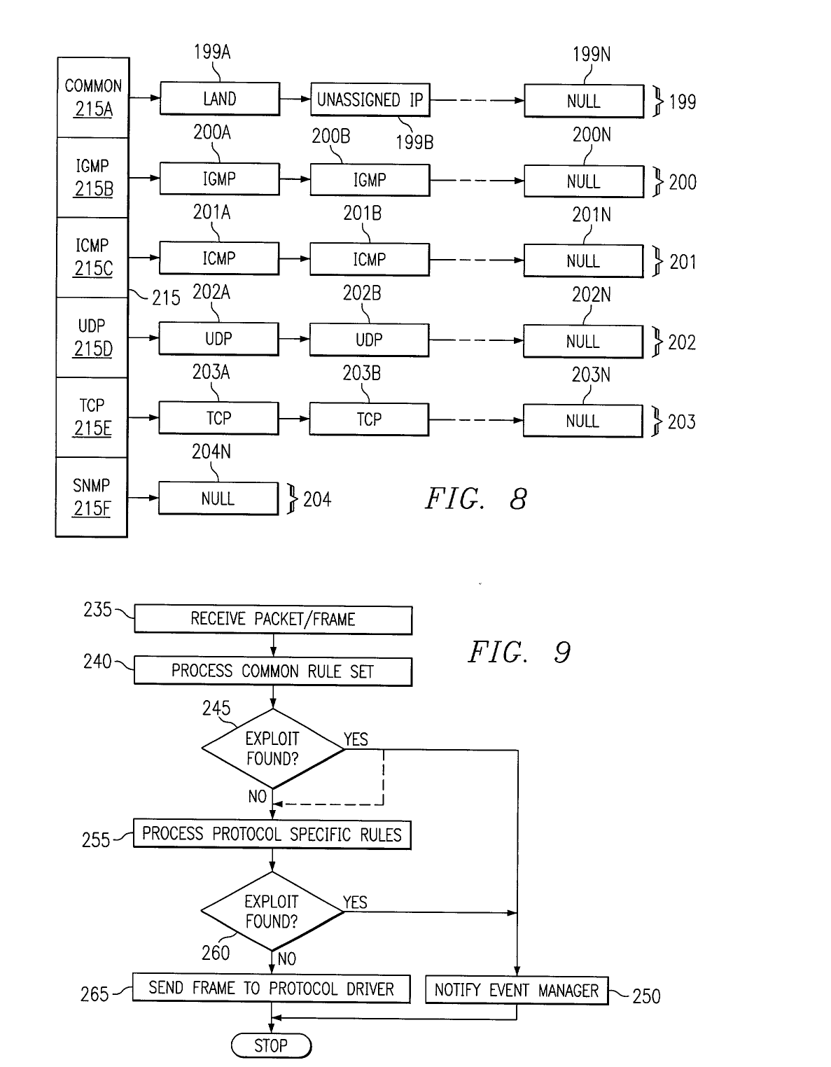

A table 215, as illustrated in FIG. 8, that maintains the parametric association of rules in a hierarchical manner is preferably managed within each respective node having an instance of intermediate driver 147 within protocol stack 90A according to an embodiment of the invention. As new exploits are developed and rules are designed for prohibiting and/or detecting such exploits, the newly-designed rules may be added to one or more rule sets 199-204. Each rule set 199-204 may be protocol-specific or protocol independent. For example, rule sets 200-204 respectively comprise rules defining Internet group management protocol (IGMP), Internet control message protocol (ICMP), UDP, TCP and SNMP protocol-specific exploit signatures. Preferably, table 215 comprises an index 215B-215F to each protocol-specific rule set 200-204. Exemplary rule sets 200-203 contain two rules 200A and 200B, 201A and 201B, 202A and 202B, and 203A and 203B, each followed by a null rule, or null operator, 200N-203N. Any number of rules may be comprised within a particular rule set and the rule set is preferably dynamic and may be expanded or shortened as new exploits are discovered and signatures therefor are defined. Rule set 204 comprises only a null operator 204N and indicates no SNMP exploit rules are currently indexed by table 215.

In addition to protocol-specific rule sets 200-204, a common rule set 199 may comprise rules 199A-199N that define exploit signatures that are not protocol-specific, such as rules 199A and 199B respectively defining an exploit commonly known as a “Land” attack (described in the attached appendix) and an unassigned IP exploit rule 199B. Common rule set 199 is preferably indexed by a common rule set index 215A of table 215. Index 215A for indexing rule set 199 may be maintained in a hierarchical manner within table 215 such that common rule set 199 is searched for exploits prior to searching other protocol-specific rule sets 200-204.

With reference to FIG. 9, there is a flowchart illustrating an exemplary processing routine of common rule set 199 and the protocol specific rule sets 199-204. Associative process engine 147C, upon reception of a packet (step 235) by intermediate driver 147, processes common rule set 199 (step 240) to determine whether the received packet has an identifiable signature (step 245) having a corresponding rule defined therefor and maintained within common rule set 199 by invoking a signature analysis process such as pattern-matching or another signature recognition technique. If a common rule signature is matched with the received packet, indicating detection of an intrusion-event, a notification thereof is provided to management node 85 (step 250) and/or the intrusion event may be logged in an event database. If an exploit comprised within common rule set 199 is not found, protocol-specific rule sets 200-204 are processed (step 255). An evaluation is made to determine whether the received packet comprises a protocol-specific exploit (step 260). If a protocol-specific exploit is found, a notification thereof is provided to management node 85 (step 250) and/or the detection intrusion-event may be logged in an event database. If, however, a protocol-specific exploit is not found, the received packet may be passed to protocol driver 135 (FIG. 6) where it may be processed for outbound or inbound transmission.

[image]

What is claimed:

1. A method of identifying data in a network exploit, comprising:
receiving a packet by an intrusion prevention system maintained by a node of a network, the intrusion prevention system bound to a media access control driver and a protocol driver;
invoking a signature analysis algorithm by the intrusion prevention system; and
comparing the packet by the intrusion prevention system with a first rule set comprising a rule logically defining a packet signature.

2. The method according to claim 1, wherein receiving a packet by an intrusion prevention system further comprises receiving a packet originating from the node.

3. The method according to claim 1, wherein receiving a packet by an intrusion prevention system further comprises receiving a packet originating from a source external to the node, the packet addressed to the node.

4. The method according to claim 1, further comprising discarding the packet upon determination that a signature of the packet corresponds to the rule.

5. The method according to claim 1, wherein comparing the packet by an intrusion prevention system with a first rule set further comprises comparing the packet by the intrusion prevention system with a second rule set upon determination that a signature of the packet does not correspond to a rule of the first rule set.

6. The method according to claim 1, wherein comparing the packet by the intrusion prevention system with a first rule set further comprises comparing the packet by the intrusion prevention system with a rule set comprising a plurality of rules each respectively comprising machine-readable code logically defining a packet signature.

7. A node of a network maintaining an instance of an intrusion prevention system for identifying data in a network exploit, the node comprising:
a central processing unit;
a memory module for storing data in machine-readable format for retrieval and execution by the central processing unit; and
an operating system comprising a network stack comprising a protocol driver, a media access control driver and an instance of the intrusion prevention system bound to the protocol driver and the media access control driver, the intrusion prevention system comprising an associative process engine and an input/output control layer, the input/output control layer operable to receive a signature file generated from a network exploit rule comprising an operand, an operator and a mask, the input/output control layer operable to pass the signature file to the associative process engine, the associative process engine operable to analyze a data packet with the signature file and assign a logical value to the signature file dependent upon a result from the analysis.

8. The node according to claim 7, wherein the exploit rule further comprises a composite of a plurality of rules, each rule comprising an operand, an operator and a mask and having a logical value, each of the plurality of rules being logically connected with at least one of the other plurality of rules by a non-bitwise boolean operator, the logical value of the signature file dependent on the logical value of each of the plurality of rules.

9. The node according to claim 7, wherein the operand comprises network frame data, the operator comprises a bitwise operation, and the mask comprises an operator mask.

10. The node according to claim 7, wherein the network control layer is operable to receive a plurality of signature files each respectively generated from a network exploit rule.

11. The node according to claim 10, wherein a parametric association is assigned to a subset of the plurality of signature files, the associative process engine operable to determine a parametric value of the packet and to analyze the packet with the subset of the signature files when the parametric association of the signature files coincide with the parametric value of the packet.

12. The node according to claim 11, wherein the parametric value of the packet is obtained from link-layer header information of the packet.

13. The node according to claim 11, wherein a plurality of parametric associations are respectively assigned to a plurality of subsets of signature files.

14. The node according to claim 11, wherein the parametric association is one of a plurality of parametric associations, each of the plurality of parametric associations comprising a common subset of signature files, each signature file of the common subset respectively analyzed by the associative process engine against the network packet prior to analyzation of any other signature files of any other subsets of signature files.

15. The node according to claim 10, further comprising a table maintained in the memory module, the table comprising a plurality of indices each respectively indexing a subset of the plurality of subsets of signature files.

16. The node according to claim 7, wherein the intrusion prevention system further comprises an intrusion event manager, the associative process engine operable to communicate that the analysis of the packet indicates a correspondence with the signature file, the intrusion event manager operable to generate an alert that is transmitted from the node to at least one of a management node in a network and an event database maintained by the node.

17. A computer-readable medium having stored thereon a set of instructions to be executed, the set of instructions, when executed by a processor, cause the processor to perform a computer method of:
reading a data packet;
selecting a set of a plurality of signature files from a plurality of sets of signature files, each respective signature file of the plurality of sets of signature files generated from a respective rule of at least one rule set comprised of a plurality of rules; and
comparing the data packet with at least one signature file of the selected set.

18. The computer readable medium according to claim 17, further comprising a set of instructions that, when executed by the processor, cause the processor to perform the computer method of determining whether a correspondence between a signature of the data packet and the at least one signature files exists.

19. The computer readable medium according to claim 17, further comprising a set of instructions that, when executed by the processor, cause the processor to perform the computer method of comparing the data packet with each signature file of the selected set of the plurality of signature files.

20. The computer readable medium according to claim 19, further comprising a set of instructions that, when executed by the processor, cause the processor to perform the computer method of:
upon determining that no correspondence exists between the signature of the data packet and the signature files of the selected set of the plurality of signature files, selecting a second set of signature files from the plurality of sets of signature files; and
comparing the signature of the data packet to at least one signature file of the second set of signature files.
